(19) United States
(12) Patent Application Publication
(10) Pub. No.: US 2011/0141250 A1
(43) Pub. Date: Jun. 16, 2011

(54) STEREO-IMAGE DISPLAY APPARATUS

(76) Inventors: HUANG-TZUNG JAN, Longtan Township (TW); SUN-CHEN WANG, Longtan Township (TW); CHIH-PEI CHEN, Longtan Township (TW)

(21) Appl. No.: 12/638,812

(22) Filed: Dec. 15, 2009

(51) Int. Cl. H04N 13/04

(52) U.S. Cl. 348/58; 348/E13.075

(57) ABSTRACT

The invention discloses a stereo-image display device. The stereo-image display device includes a light source, a polarization beam splitter, two image modulators and an image projection lens set. The light source is used for generating a parallel beam. The polarization beam splitter is used for splitting the parallel beam into two polarization orthogonal beams. Each image modulator is used for generating one visualized optical signal according to one of the beams and reflecting the visualized optical signal to the polarization beam splitter. Two visualized optical signals are to combine to one beam by the polarization beam splitter, and are projected through the image projection lens set onto a screen.

### BACKGROUND OF THE INVENTION

1. Field of the Invention

The invention relates to a stereo-image display apparatus and, more particularly, to a reflective panel stereo-image display apparatus and the optical structure thereof.

2. Description of the Prior Art

Recently, consumer electronic products are developing rapidly. Kinds of digital electronic display devices are popular in our daily life. Electronic display devices are implements in products like mobile phones, interactive advertisement panels, LCD televisions and laptop computers. In order to provide more real display effect, the electronic display device begins its revolution from two dimensional to three dimensional displaying.

Take the stereo movie for example, the audiences may wear a stereo eye glasses with red and blue optical filters. Each frame of the movie contains a left eye image and a right eye image with different color lights. The left eye and right eye images are filtered through different optical filters and respectively projected to two eyes of the audiences. A parallax existed between the left eye and right eye images are utilized to form a stereo vision to the audiences. This kind of stereo movies is well developed, but it has some color-bias problems in displaying.

Besides, the theory of stereo display with polarization glasses utilizes two projectors to cast left eye and right eye image synchronously. The polarization glasses are utilized to filter the left eye and right eye images, which are projected to two eyes of the audiences respectively. Please refer to FIG. 1. FIG. 1 is a schematic diagram illustrating a stereo-image display system 1 (e.g. stereo movie casting system) in prior art. It needs two independent projecting displayers (10, 12) for generating left eye and right eye images with vision messages, and projecting them onto one screen 14 synchronously. The images projected by these two independent projecting displayers (10, 12) have to be overlapping exactly, or the outcome image will be vague. In order to achieve ideal displaying effect, the implementations of the projecting displayers must be performed by a skilled engineer, such that the cost of the stereo display is still too high to be applied in personal or family applications.

Accordingly, the invention discloses a stereo-image display apparatus, which utilizes one singular display device for controlling the polarization state of optical signals and projecting left eye and right eye images on the same optical pattern synchronously, so as to solve said problems.

### SUMMARY OF THE INVENTION

A scope of the invention is to provide a stereo-image display apparatus. In practical applications, the stereo-image display apparatus can be a reflective panel stereo-image display apparatus.

According to an embodiment, the stereo-image display apparatus includes a light source, a polarization beam splitter, a first image modulator, a second image modulator and an image projection lens set. The light source is used for generating a parallel beam. The polarization beam splitter is used for splitting the parallel beam into a first beam and a second beam. A polarized state of the first beam is orthogonal to a polarized state of the second beam. The first image modulator is used for generating a first visualized optical signal according to the first beam. The first image modulator transforms a polarized state of the first visualized optical signal into another orthogonal polarized state and reflects the first visualized optical signal to the polarization beam splitter. The second image modulator is used for generating a second visualized optical signal according to the second beam. The second image modulator transforms a polarized state of the second visualized optical signal into another orthogonal polarized state and reflects the second visualized optical signal to the polarization beam splitter. The first visualized optical signal and the second visualized optical signal are combined to one combined beam by the polarization beam splitter. The combined beam is projected through the image projection lens set onto a screen.

According to another embodiment, the stereo-image display apparatus includes a light source, a polarization beam splitter, a first image modulator, a second image modulator and an image projection lens set. The light source is used for generating a parallel beam. The polarization beam splitter is used for splitting the parallel beam into a first beam and a second beam. The first beam and the second beam are respectively a linear polarized beam. A polarized direction of the first beam is perpendicular to a polarized direction of the second beam. The first image modulator is used for generating a first visualized optical signal according to the first beam. The first image modulator rotates a polarized direction of the first visualized optical signal by 90 degree and reflects the first visualized optical signal to the polarization beam splitter. The second image modulator is used for generating a second visualized optical signal according to the second beam. The second image modulator rotates a polarized direction of the second visualized optical signal by 90 degree and reflects the second visualized optical signal to the polarization beam splitter. The first visualized optical signal and the second visualized optical signal are combined to one combined beam by the polarization beam splitter. The combined beam is projected through the image projection lens set onto a screen.

Compared to the stereo-image display device in prior art (e.g. polar optical displayer) may only achieve 50% optical energy utilization efficiency, or in some other cases, some complex S-P polarization converters are needed to raise the optical energy utilization efficiency. The invention utilizes the polarization beam splitter to split one beam into two beams with orthogonal polarization states (e.g. two beams are S-polarized and P-polarized respectively). These two beams are projected to two image modulator. Then, each image modulator is used for modulate one beam into one visualized optical signal with visual messages and reflecting the visualized optical signal back to the polarization beam splitter. In the meantime, the polarization state of the visualized optical signal is transformed to another polarization state orthogonal to the original polarization state of the input beam. Two visualized optical signal are combined into one combined beam by the polarization beam splitter. Then, the combined beam is projected on the screen capable of maintaining optical polarization. In this case, the audiences may wearing a stereo eye glasses with differential polarization state filters may see the stereo vision image clearly.

Accordingly, once the digital signals with left eye vision and right eye vision messages are inputted to the stereo-image display apparatus in the invention, the stereo-image display apparatus may broadcast a stereo image. It needs no complex implementation operation. The stereo-image display apparatus can be applied in family application. Besides, the invention utilizes two polarization states of one regular light source, such that it has higher energy utilization efficiency.

The advantage and spirit of the invention may be understood by the following recitations together with the appended drawings.

### BRIEF DESCRIPTION OF THE APPENDED DRAWINGS

FIG. 1 is a schematic diagram illustrating a stereo-image display system in prior art.

FIG. 2 is a schematic diagram illustrating a stereo-image display apparatus according to an embodiment of the invention.

FIG. 3A is a schematic diagram illustrating the light splitting operation of the polarization beam splitter in FIG. 2.

FIG. 3B is a schematic diagram illustrating the light converging operation of the polarization beam splitter in FIG. 2.

FIG. 4 is a schematic diagram illustrating a stereo-image display apparatus according to another embodiment of the invention.

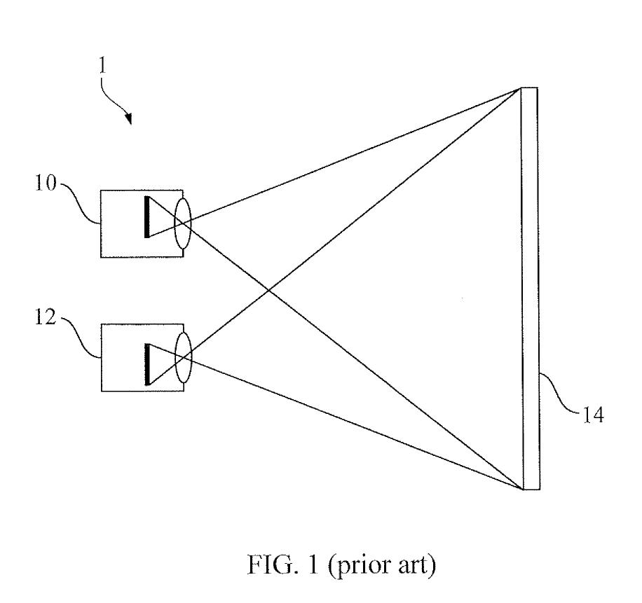

### DETAILED DESCRIPTION OF THE INVENTION

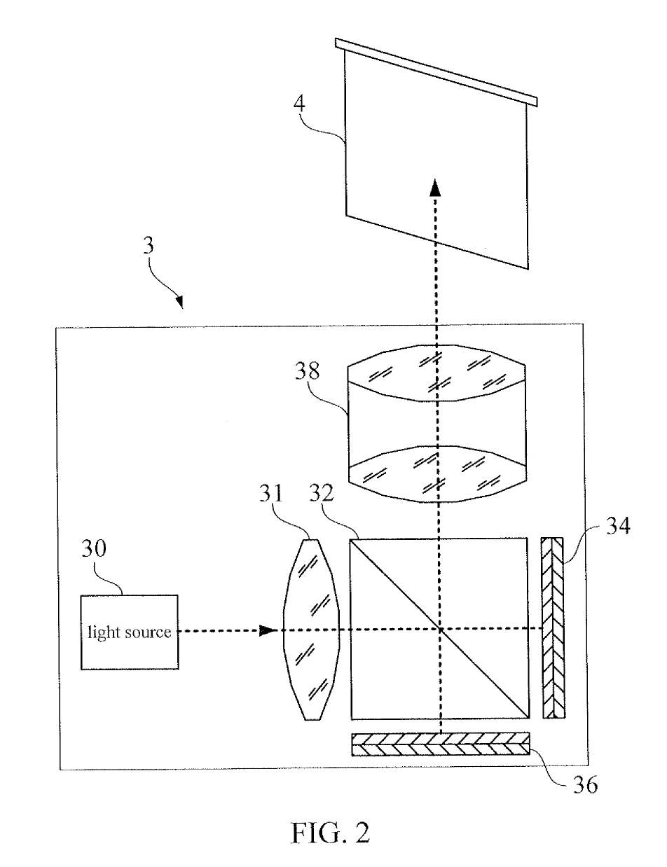

Please refer to FIG. 2. FIG. 2 is a schematic diagram illustrating a stereo-image display apparatus 3 according to an embodiment of the invention. As shown in FIG. 2, the stereo-image display apparatus 3 includes a light source 30, a polarization beam splitter 32, a first image modulator 34, a second image modulator 36 and an image projection lens set 38.

In this embodiment, the light source can be a white light-emitting diode component for generating a parallel beam. In practical applications, the stereo-image display apparatus 3 may further include a condensing lens 31 (as shown in FIG. 2). The condensing lens 31 is disposed between the light source 30 and the polarization beam splitter 32. The condensing lens 31 may redirect some scattering light generated by the white light-emitting diode component, so as to cooperate with the light source 30 for generating a stable and even parallel beam.

When the parallel beam generated by the light source 30 passes the condensing lens 31 and enters the polarization beam splitter 32, the polarization beam splitter 32 split the parallel beam into a first beam and a second beam. The first beam and the second beam are one pair of beams with their polarized state orthogonal to each other.

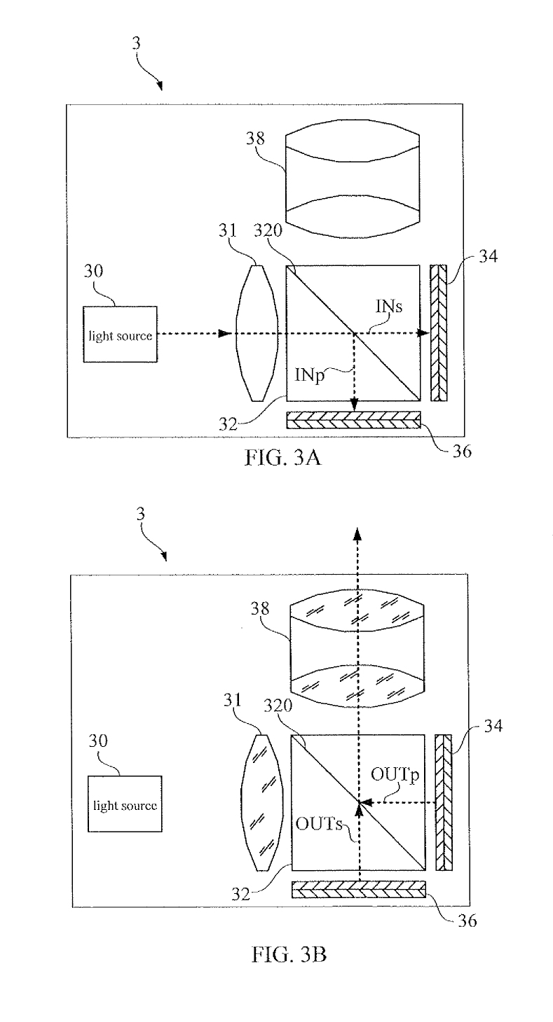

Please refer to FIG. 3A. FIG. 3A is a schematic diagram illustrating the light splitting operation of the polarization beam splitter 32 in FIG. 2. When the parallel beam pass a polarization selective plane 320 of the polarization beam splitter 32, the S-polarization part of light radiation is extracted from the parallel beam and forms a first beam INs. The first beam INs is projected in a straight line to the first image modulator 34. In the mean time, the P-polarization part of light radiation is extracted from the parallel beam and forms a second beam INp. The second beam INp is reflected by the polarization selective plane 320, such that the second beam INp turns a specific angle (in this FIG. 3A case, it turns 90° downward) and is projected to the second image modulator 36. The polarized directions of the first beam INs and the second beam INp are perpendicular to each other.

After that, please refer to FIG. 3B. FIG. 3B is a schematic diagram illustrating the light converging operation of the polarization beam splitter 32 in FIG. 2. The first image modulator 34 is used for generating a first visualized optical signal OUTp according to the first beam INs and reflecting the first visualized optical signal OUTp to the polarization beam splitter 32. The second image modulator 36 is used for generating a second visualized optical signal OUTs according to the second beam INp and reflecting the second visualized optical signal OUTs to the polarization beam splitter 32.

To be noticed that, the first image modulator 34 and the second image modulator 36 respectively modulate the even light radiations (i.e. the first beam INs and the second beam INp) into visualized optical signals with left/right eye video messages (i.e. the first visualized optical signal OUTp and the second visualized optical signal OUTs). In other words, the first visualized optical signal OUTp and the second visualized optical signal OUTs correspond to a left eye vision and a right eye vision respectively.

In the meantime, the first image modulator 34 performs a modulation on the polarized direction of the first beam INs, such that the polarized direction of the first visualized optical signal OUTp reflected back to the polarization beam splitter is P-polarized (rotate by 90 degree from S-polarized to P-polarized). The second image modulator 36 performs a modulation on the polarized direction of the second beam INp, such that the polarized direction of the second visualized optical signal OUTs reflected back to the polarization beam splitter is S-polarized (rotate by 90 degree from P-polarized to S-polarized).

Afterward, when the first visualized optical signal OUTp enters the polarization beam splitter 32 and passes the polarization selective plane 320, the first visualized optical signal OUTp is reflected by the polarization selective plane 320, such that the first visualized optical signal OUTp turns a specific angle (in this FIG. 3B case, it turns 90° upward) and is projected to the image projection lens set 38. On the other hand, when the second visualized optical signal OUTs enters the polarization beam splitter 32, the second visualized optical signal pass through the polarization selective plane 320 in a straight line directly to the image projection lens set 38. In this way, the first visualized optical signal OUTp and the second visualized optical signal OUTs are converged on one optical pattern to form one combined beam.

At last, the combine beam (including the first visualized optical signal OUTp and the second visualized optical signal OUTs) is projected through the image projection lens set 38 onto a screen 4. In this way, audiences wearing stereo eye glasses with S-polarization filter and P-polarization filter may see the stereo vision image clearly. In practical applications, the screen 4 can be a screen capable of maintaining optical polarization.

In aforesaid embodiment, the image modulator 34 and the second image modulator 36 can respectively be a Liquid Crystal on Silicon (LCoS) panel in practical application. In this embodiment, the first image modulator 34 can be a P-LCoS panel, and the second image modulator 36 can be an S-LCoS panel. In other word, the stereo-image display apparatus in the invention can be a reflective panel stereo-image display apparatus.

Besides, the image projection lens set 38 in the aforesaid embodiment is a front projection lens, such that the stereo-image display apparatus 3 is a front projecting stereo-image display device in this case, but the invention is not limited to this.

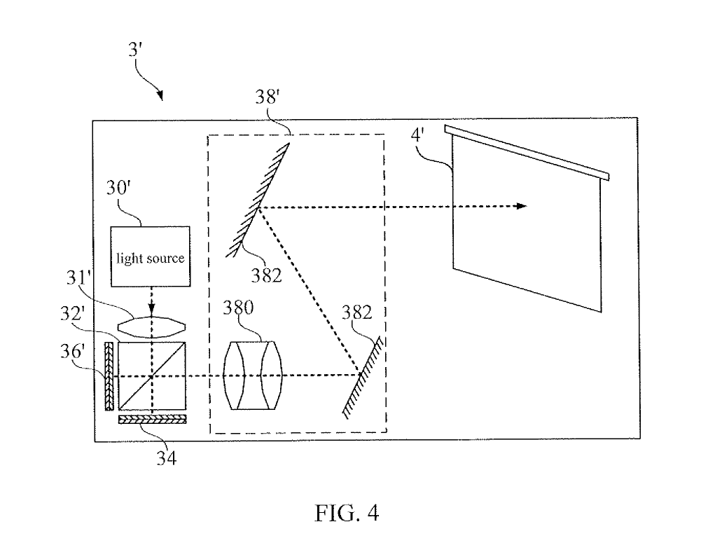

Please refer to FIG. 4. FIG. 4 is a schematic diagram illustrating a stereo-image display apparatus 3′ according to another embodiment of the invention. In this embodiment, the stereo-image display apparatus 3′ includes a light source 30′, a condensing lens 31′, a polarization beam splitter 32′, a first image modulator 34′, a second image modulator 36′ and an image projection lens set 38′.

The main difference between the stereo-image display apparatus 3′ and the aforesaid embodiment is that, the image projection lens set 38′ of the stereo-image display apparatus 3′ includes a fixed-focus lens 380 and two reflecting mirrors 382. The visualized optical signals go through the fixed-focus lens 380. Then the visualized optical signals are sequentially reflected by two reflecting mirrors 382 and projected to the polarization maintaining screen 4′. The fixed-focus lens 380 and these two reflecting mirrors 382 form a back projection lens set, such that the stereo-image display apparatus 3′ is a back projecting stereo-image display device (e.g. back projecting television). Other internal components and operating behaviors of the stereo-image display apparatus 3′ in this embodiment are similar to the aforesaid embodiment, so not to be repeated here.

In summary, the invention utilizes the polarization beam splitter to split one beam into two beams with orthogonal polarization states (e.g. two beams are S-polarized and P-polarized respectively). These two beams are projected to two image modulator. Then, each image modulator is used for modulate one beam into one visualized optical signal with visual messages and reflecting the visualized optical signal back to the polarization beam splitter. In the meantime, the polarization state of the visualized optical signal is transformed to another polarization state orthogonal to the original polarization state of the input beam. Two visualized optical signal are combined into one combined beam by the polarization beam splitter. Then, the combined beam is projected on the screen capable of maintaining optical polarization. In this ease, the audiences wearing stereo eye glasses with differential polarization state filters may see the stereo vision image clearly.

Accordingly, once the digital signals with left eye vision and right eye vision messages are inputted to the stereo-image display apparatus in the invention, the stereo-image display apparatus may broadcast a stereo image. It needs no complex implementation operation. The stereo-image display apparatus can be applied in family application. Besides, the invention utilizes two polarization states of one regular light source, such that it has higher energy utilization efficiency.

In aforesaid embodiments, the first beam and the second beam generated by the polarization beam splitter is linear polarized (e.g. S-polarized or P-polarized). The first visualized optical signal and the second visualized optical signal are also S-polarized or P-polarized, but the invention is not limited to linear polarized radiation.

In another embodiment, the first beam generated by the polarization beam splitter can be a left-handed elliptically polarization beam, and the second beam generated by the polarization beam splitter can be a right-handed elliptically polarization beam. Or alternatively, the first beam can be a right-handed elliptically polarization beam, and the second beam can be a left-handed elliptically polarization beam. Accordingly, the image modulators may generate a pair of visualized optical signals with left-handed and right-handed elliptically polarization. The visualized optical signals are combined to one combined beam for forming a stereo vision on a polarization maintaining screen. In other words, the stereo-image display apparatus may also adopt elliptically polarization beam. Other internal components and operating behaviors of the stereo-image display apparatus are substantially similar to the aforesaid embodiment, so not to be repeated here.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A stereo-image display apparatus, comprising:
a light source, used for generating a parallel beam;
a polarization beam splitter, used for splitting the parallel beam into a first beam and a second beam, a polarized state of the first beam being orthogonal to a polarized state of the second beam;
a first image modulator, used for generating a first visualized optical signal according to the first beam, the first image modulator transforming a polarized state of the first visualized optical signal into another orthogonal polarized state and reflecting the first visualized optical signal to the polarization beam splitter;
a second image modulator, used for generating a second visualized optical signal according to the second beam, the second image modulator transforming a polarized state of the second visualized optical signal into another orthogonal polarized state and reflecting the second visualized optical signal to the polarization beam splitter; and
an image projection lens set;
wherein the first visualized optical signal and the second visualized optical signal are combined to one combined beam by the polarization beam splitter, and the combined beam is projected through the image projection lens set onto a screen.

2. The stereo-image display apparatus of claim 1, wherein the first visualized optical signal and the second visualized optical signal correspond to a left eye vision and a right eye vision respectively.

3. The stereo-image display apparatus of claim 1, wherein the first beam generated by the polarization beam splitter is a left-handed elliptically polarization beam and the second beam generated by the polarization beam splitter is a right-handed elliptically polarization beam.

4. The stereo-image display apparatus of claim 1, wherein the first beam generated by the polarization beam splitter is a right-handed elliptically polarization beam and the second beam generated by the polarization beam splitter is a left-handed elliptically polarization beam.

5. The stereo-image display apparatus of claim 1, wherein the first image modulator performs a modulation on the polarized state of the first beam, such that the first visualized optical signal reflected back to the polarization beam splitter is transformed into another orthogonal polarized state, and the second image modulator performs a modulation on the polarized state of the second beam, such that the second visualized optical signal reflected back to the polarization beam splitter is transformed into another orthogonal polarized state.

6. The stereo-image display apparatus of claim 1, wherein the light source comprises a white light-emitting component.

7. The stereo-image display apparatus of claim 1, wherein the screen is a screen capable of maintaining optical polarization.

8. The stereo-image display apparatus of claim 1, wherein the image projection lens set comprises a front projection lens.

9. The stereo-image display apparatus of claim 1, wherein the image projection lens set comprises a fixed-focus lens and two reflecting mirrors, the first visualized optical signal and the second visualized optical signal go through the fixed-focus lens, then the first visualized optical signal and the second visualized optical signal are sequentially reflected by two reflecting mirrors and projected to the screen capable of maintaining optical polarization, and the fixed-focus lens and the reflecting mirrors form a back projection lens set.

10. A stereo-image display apparatus, comprising:
a light source, used for generating a parallel beam;
a polarization beam splitter, used for splitting the parallel beam into a first beam and a second beam, the first beam and the second beam being a linear polarized beam respectively, a polarized direction of the first beam being perpendicular to a polarized direction of the second beam;
a first image modulator, used for generating a first visualized optical signal according to the first beam, the first image modulator rotating a polarized direction of the first visualized optical signal by 90 degree and reflecting the first visualized optical signal to the polarization beam splitter;
a second image modulator, used for generating a second visualized optical signal according to the second beam, the second image modulator rotating a polarized direction of the second visualized optical signal by 90 degree and reflecting the second visualized optical signal to the polarization beam splitter; and
an image projection lens set;
wherein the first visualized optical signal and the second visualized optical signal are combined to one combined beam by the polarization beam splitter, and the combined beam is projected through the image projection lens set onto a screen.

11. The stereo-image display apparatus of claim 10, wherein the first visualized optical signal and the second visualized optical signal correspond to a left eye vision and a right eye vision respectively.

12. The stereo-image display apparatus of claim 10, wherein the polarized direction of the first beam generated by the polarization beam splitter is S-polarized and the polarized direction of the second beam generated by the polarization beam splitter is P-polarized.

13. The stereo-image display apparatus of claim 12, wherein the first image modulator performs a modulation on the polarized direction of the first beam, such that the polarized direction of the first visualized optical signal reflected back to the polarization beam splitter is P-polarized, and the second image modulator performs a modulation on the polarized direction of the second beam, such that the polarized direction of the second visualized optical signal reflected back to the polarization beam splitter is S-polarized.

14. The stereo-image display apparatus of claim 10, wherein the polarized direction of the first beam generated by the polarization beam splitter is P-polarized and the polarized direction of the second beam generated by the polarization beam splitter is S-polarized.

15. The stereo-image display apparatus of claim 14, wherein the first image modulator performs a modulation on the polarized direction of the first beam, such that the polarized direction of the first visualized optical signal reflected back to the polarization beam splitter is S-polarized, and the second image modulator performs a modulation on the polarized direction of the second beam, such that the polarized direction of the second visualized optical signal reflected back to the polarization beam splitter is P-polarized.

16. The stereo-image display apparatus of claim 10, wherein the light source comprises a white light-emitting component.

17. The stereo-image display apparatus of claim 10, wherein the screen is a screen capable of maintaining optical polarization.

18. The stereo-image display apparatus of claim 10, wherein the image projection lens set comprises a front projection lens.

19. The stereo-image display apparatus of claim 10, wherein the image projection lens set comprises a fixed-focus lens and two reflecting mirrors, the first visualized optical signal and the second visualized optical signal go through the fixed-focus lens, then the first visualized optical signal and the second visualized optical signal are sequentially reflected by two reflecting mirrors and projected to the screen capable of maintaining optical polarization, and the fixed-focus lens and the reflecting mirrors form a back projection lens set.
